(19) United States
(12) Patent Application Publication
(10) Pub. No.: US 2026/0318351 A1
(43) Pub. Date: Oct. 15, 2026

(54) CRANKSHAFT ASSEMBLY FOR AN INTERNAL COMBUSTION ENGINE

(71) Applicant: CUMMINS INC., Columbus, IN (US)

(72) Inventors: Anil Ashok Tiwari, Pune (IN); Priti Prakash Sawaikar, Pune (IN)

(73) Assignee: CUMMINS INC., Columbus, IN (US)

(21) Appl. No.: 19/629,414

(22) Filed: Mar. 26, 2026

(30) Foreign Application Priority Data
Apr. 9, 2025 (IN) 202541034744
Mar. 9, 2026 (IN) 202541034744

(51) Int. Cl. F16C 3/06; B25B 13/48; F16F 15/14

(52) U.S. Cl. CPC F16C 3/06; F16F 15/1407; B25B 13/48; F16F 2222/08; F16F 2232/02

(57) ABSTRACT

A crankshaft assembly for an internal combustion engine includes a crankshaft defining a plurality of first apertures, a damper defining a plurality of second apertures, and a barring interface component configured to be engaged by a barring tool to facilitate rotation of the crankshaft assembly. The barring interface component defines a plurality of third apertures. Each of the plurality of third apertures is configured to align with one of the plurality of first apertures and one of the plurality of second apertures to selectively receive one of a plurality of fasteners to couple the barring interface component and the damper to the crankshaft.

### CROSS-REFERENCE TO RELATED APPLICATIONS

The present application claims priority to Indian Provisional Patent Application No. 202541034744, filed Apr. 9, 2025 and Indian Non-Provisional Patent Application No. 202541034744, filed Mar. 9, 2026. The contents of this application are incorporated herein by reference.

### TECHNICAL FIELD

The present application relates generally to systems for rotating and adjusting components of an internal combustion engine.

### BACKGROUND

In an engine system, engine valves are set during service or repair. For optimized engine valve settings, an operator may rotate components of the engine system. A barring tool is used to rotate the components when setting the engine valve settings.

### SUMMARY

According to one embodiment, a crankshaft assembly for an internal combustion engine includes a crankshaft defining a plurality of crankshaft apertures, and a barring interface component configured to be engaged by a barring tool to facilitate rotation of the crankshaft assembly. The barring interface component defines a plurality of barring interface mounting apertures, each of the plurality of barring interface mounting apertures configured to align with one of the plurality of crankshaft apertures to selectively receive one of a plurality of fasteners to couple the barring interface component to the crankshaft.

According to another embodiment, an engine system comprises an engine including a plurality of cylinders and a crankshaft assembly coupled to the plurality of cylinders and configured to be driven to rotate by combustion within the plurality of cylinders. The crankshaft assembly includes a crankshaft defining a plurality of crankshaft apertures, and a barring interface component configured to be engaged by a barring tool to facilitate rotation of the crankshaft assembly. The barring interface component defines a plurality of barring interface mounting apertures, each of the plurality of barring interface mounting apertures configured to align with one of the plurality of crankshaft apertures to selectively receive one of a plurality of fasteners to couple the barring interface component to the crankshaft.

### BRIEF DESCRIPTION OF THE FIGURES

The disclosure will become more fully understood from the following detailed description, taken in conjunction with the accompanying Figures, wherein like reference numerals refer to like elements unless otherwise indicated, in which:

FIG. 1 is a block schematic diagram of an internal combustion engine system according to one embodiment;

FIG. 2 is a perspective view of a portion of an example crankshaft assembly usable in the internal combustion engine system of FIG. 1;

FIG. 3 is a cross-sectional-view of the portion of the crankshaft assembly of FIG. 2; and

FIG. 4 is a perspective view of a barring interface of the crankshaft assembly of FIG. 2.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

Following below are more detailed descriptions of various concepts related to, and implementations of, methods, and apparatuses, of an engine system. The various concepts introduced above and discussed in greater detail below may be implemented in any of a number of ways, as the described concepts are not limited to any particular manner of implementation. Examples of specific implementations and applications are provided primarily for illustrative purposes.

Internal combustion engine systems (e.g., hydrogen internal combustion engine systems, hydrocarbon internal combustion engine systems, diesel internal combustion engine systems, etc.) utilize combustion in an internal combustion engine of the internal combustion engine system in order to output torque. However, during servicing (e.g., maintenance, calibration, repair, etc.) of the internal combustion engine systems, an operator may need to manually rotate components of the internal combustion engine (e.g., operate components without allowing for combustion in the internal combustion engine, etc.). For example, when an operator of the internal combustion engine is adjusting valve settings of engine valves (e.g., valve lash of the engine valves, etc.) of the internal combustion engine, the operator may need to rotate a crankshaft of the internal combustion engine. Adaptationally, the operator may verify correct rotation of the components of the internal combustion engine based on indicators associated with the internal combustion engine. Thus, by providing an engagement interface (e.g., a barring interface, etc.) manually rotating the components of the internal combustion engine, the operator may more easily service the internal combustion engine systems.

Implementations herein relate to a crankshaft assembly for an internal combustion engine of an internal combustion engine system including a barring interface configured to be engaged by a barring tool to manually rotate the crankshaft assembly. An operator may utilize the barring tool during surfacing of the internal combustion engine system to rotate a crankshaft of the crankshaft assembly. For example, when adjusting a valve setting of an engine valve of the internal combustion engine, the operator may utilize a barring tool to rotate the crankshaft via the barring interface. The barring interface may be coupled to a damper of the crankshaft assembly and/or to the crankshaft. Additionally, the barring interface may be positioned such that the operator may visualize rotational indicators of the internal combustion engine such that the operator may easily rotate the crankshaft to various rotational positions associated with serving of the internal combustion engine.

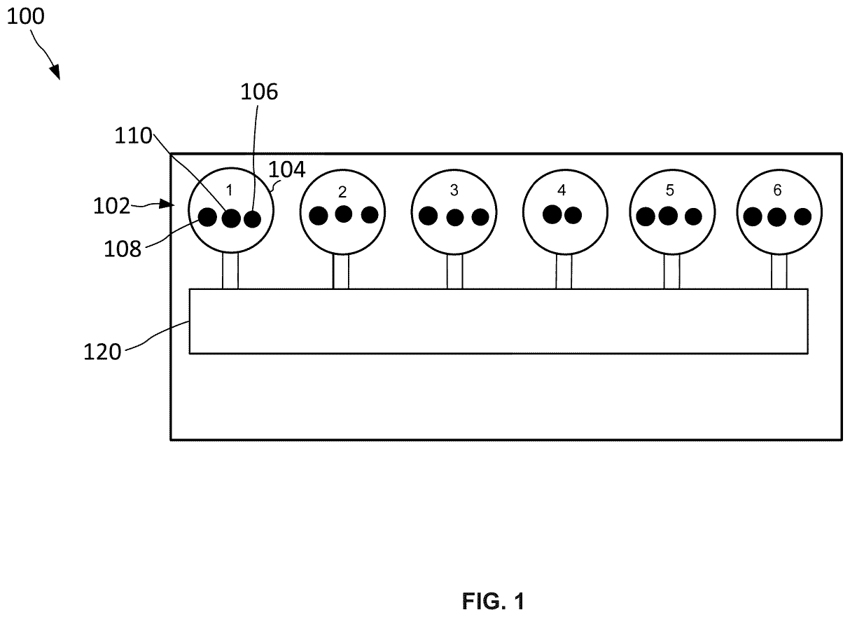

FIG. 1 is a schematic representation of an example internal combustion engine system 100. The internal combustion engine system 100 may be implemented in a vehicle (e.g., car, truck, construction vehicle, municipal vehicle, military vehicle, maritime vessel, etc.), generator (e.g., genset, etc.), or other similar engine-based application.

The internal combustion engine system 100 includes an engine 102. The engine 102 includes a plurality of cylinders 104. Each of the plurality of cylinders 104 includes a fuel injector 106, an engine valve 108, and a spark plug 110. The fuel injector 106 is configured to provide (e.g., dose, inject, etc.) an amount of fuel (e.g., hydrogen, etc.) into one of the cylinders 104. The engine valve 108 is configured to provide (e.g., dose, inject, etc.) an amount of air into one of the cylinders 104. In some embodiments, the engine valve 108 is configured to provide an amount of exhaust gas into one of the cylinders 104. The spark plug 110 is configured to provide energy (e.g., a spark, etc.) to ignite combustion of the fuel provided by the fuel injector 106 and the air provided by the engine valve 108 within each of the cylinders 104. For example, the spark provided by the spark plug 110 may ignite combustion of a mixture of fuel from the fuel injector 106 and air provided by the engine valve 108 within each of the cylinders 104.

The engine 102 includes a crankshaft assembly 120. The crankshaft assembly 120 is coupled to the cylinders 104 and is configured to be driven by the combustion within each of the cylinders 104. For example, the combustion within each of the cylinders 104 may provide a force to the crankshaft assembly 120 that causes rotation of the crankshaft assembly 120. The rotation of the crankshaft assembly 120 may correspond to power (e.g., torque, etc.) generated by the combustion within each of the cylinders 104.

The crankshaft assembly 120 may be coupled to the engine valves 108. The rotation of the crankshaft assembly 120 may cause the engine valves 108 to actuate to provide the air into the cylinders 104. For example, the crankshaft assembly 120 may be coupled to the engine valves 108 via a belt such that the rotation of the crankshaft assembly 120 actuates the engine valves 108 to provide the air into the cylinders 104.

As a result of the coupling of the crankshaft assembly 120 and the engine valves 108, an operator of the internal combustion engine system 100 may need to rotate the crankshaft assembly 120 while servicing the engine valves 108. For example, while servicing the engine valves 108, an operator may rotate the crankshaft assembly 120 into a first rotational position to adjust a valve lash (e.g., a valve clearance, etc.) of a first of the engine valves 108, a second rotational position to adjust a valve lash of a second of the engine valves 108, a third rotational position to adjust a valve lash of a third of the engine valves 108, a fourth rotational position to adjust a valve lash of a fourth of the engine valves 108, a fifth rotational position to adjust a valve lash of a fifth of the engine valves 108, and a sixth rotational position to adjust a valve lash of a sixth of the engine valves 108.

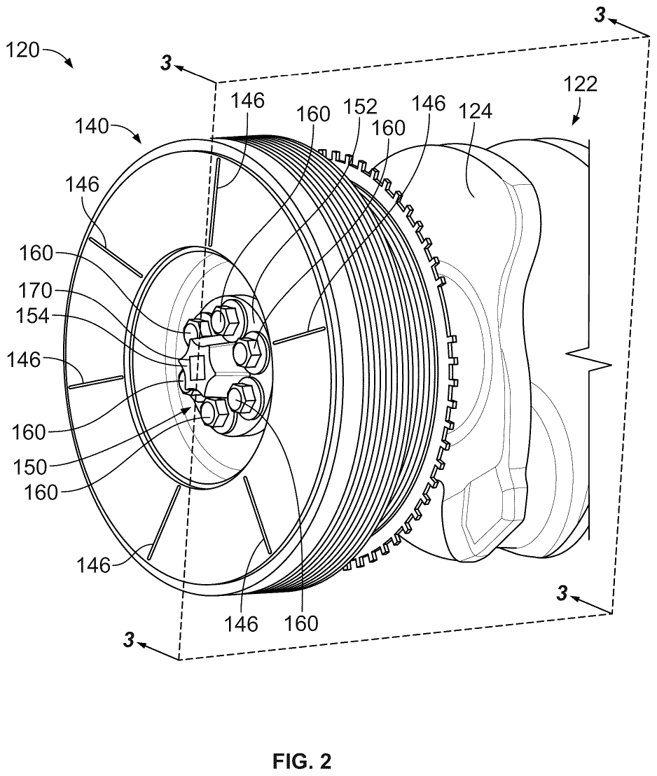

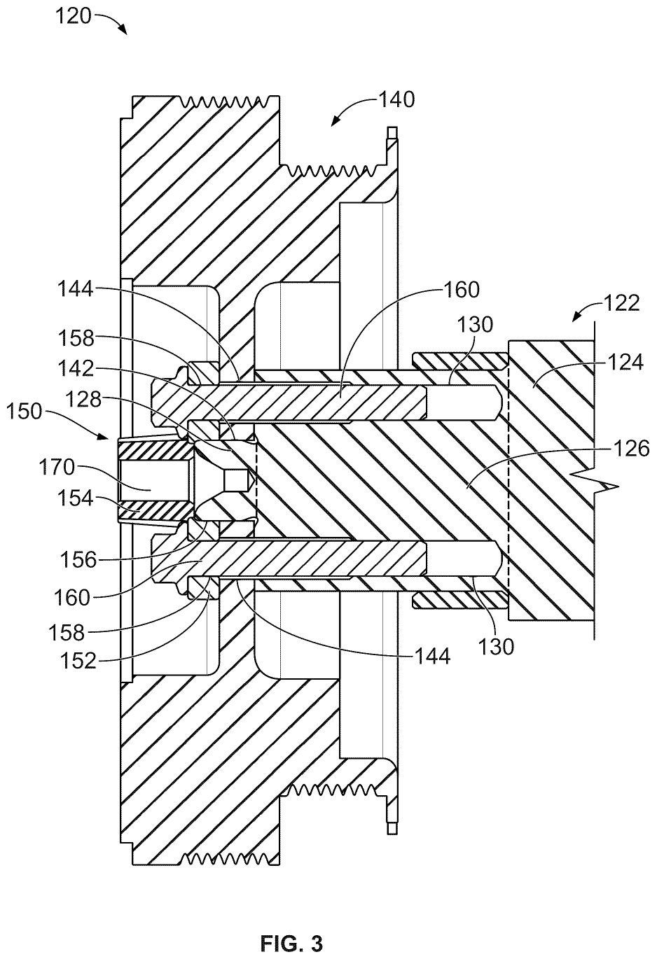

As shown in FIGS. 2 and 3, the crankshaft assembly 120 includes a crankshaft 122, a damper 140, and a barring interface component 150 (e.g., a barring tool interface). The crankshaft 122 is coupled to the cylinders 104 and is configured to be driven to rotate by combustion within the cylinders 104. For example, combustion within the cylinders 104 may provide a torque to the crankshaft 122 that causes the crankshaft 122 to rotate. The crankshaft 122 may provide the torque received from the cylinders 104 as an output torque of the internal combustion engine system 100.

The crankshaft 122 includes a crankshaft body portion 124, a crankshaft coupling portion 126, and a crankshaft alignment portion 128. The crankshaft body portion 124 is configured to couple to the cylinders 104 to receive power from the cylinders 104. For example, the crankshaft body portion 124 may include a plurality of offset cylinder interface portions, each configured to couple to one of the cylinders.

The crankshaft coupling portion 126 is configured to couple the crankshaft 122 to the damper 140 and the barring interface component 150. The crankshaft coupling portion 126 extends from the crankshaft body portion 124. The crankshaft coupling portion 126 may extend from an end (e.g., a forward end, a rearward end, etc.) of the crankshaft body portion 124. The crankshaft coupling portion 126 defines a plurality of crankshaft apertures or coupling apertures 130 (e.g., mounting holes, first apertures, etc.) extending into the crankshaft coupling portion 126. The coupling apertures 130 may extend into the crankshaft coupling portion 126 from a distal end of the crankshaft coupling portion 126. For example, a first end of the crankshaft coupling portion 126 may be coupled to the crankshaft body portion 124 and the coupling apertures 130 may extend into the crankshaft coupling portion 126 from an opposing second end of the crankshaft coupling portion 126 (e.g., towards the crankshaft body portion 124, etc.).

In some embodiments, the coupling apertures 130 do not extend into the crankshaft body portion 124. For example, the coupling apertures 130 may not extend into the crankshaft body portion 124 due to the high torque loading of the crankshaft body portion 124 from the cylinders 104 (e.g., such that the crankshaft body portion 124 is not weakened by the coupling apertures 130, etc.). As another example, the coupling apertures 130 may be entirely defined by the crankshaft coupling portion 126. In other embodiments, the coupling apertures 130 extend into the crankshaft body portion 124.

The crankshaft alignment portion 128 is configured to extend through at least a portion of the damper 140 and the barring interface component 150 to align the damper 140 and the barring interface component 150 with the crankshaft 122. The crankshaft alignment portion 128 extends from the crankshaft coupling portion 126. The crankshaft alignment portion 128 may extend from an end of the crankshaft coupling portion 126. For example, a first end of the crankshaft coupling portion 126 may be coupled to the crankshaft body portion 124 and the crankshaft alignment portion 128 may extend from a second opposing end of the crankshaft coupling portion 126. In some embodiments, the crankshaft alignment portion 128 may be centered relative to the coupling apertures 130.

The damper 140 is coupled to the crankshaft 122. The damper 140 is configured to absorb and dissipate vibrations in the crankshaft 122 to prevent damage to the crankshaft 122 and/or other components of the internal combustion engine system 100. For example, the damper 140 may utilize one or more inertial rings to absorb energy of vibrations in the crankshaft 122.

The damper 140 defines a damper bore opening 142 and a plurality of damper mounting apertures 144 (e.g., second apertures, etc.) extending through the damper 140. The damper bore opening 142 is configured to selectively align with and receive the crankshaft alignment portion 128 of the crankshaft 122 to align damper 140 with the crankshaft 122. The damper mounting apertures 144 are each configured to selectively align with one of the coupling apertures 130 of the crankshaft 122. In some embodiments, when the damper bore opening 142 receives the crankshaft alignment portion 128 of the crankshaft 122, the damper mounting apertures 144 may selectively align with the coupling apertures 130 of the crankshaft 122.

In some embodiments, the damper 140 includes a plurality of alignment indicators 146. Each of the alignment indicators 146 may indicate a rotational position of the crankshaft assembly 120 that allows for an operator to adjust a setting of one of the engine valves 108. For example, an operator may adjust a valve lash setting of a first of the engine valves 108 when a first of the alignment indicators 146 corresponding to the first of the engine valves 108 is in a particular alignment. The alignment indicators 146 may align with a corresponding indicator on another component of the internal combustion engine system 100 (e.g., a non-rotating component, etc.) to indicate the different rotational positions of the crankshaft assembly 120.

The barring interface component 150 is coupled to the crankshaft 122. The barring interface component 150 is configured to be engaged by a barring tool to facilitate manual rotation of the crankshaft assembly 120 via the barring interface component 150. For example, an operator of the internal combustion engine system 100 may engage the barring interface component 150 with a barring tool and operate the barring tool to rotate the crankshaft assembly 120 via the barring interface component 150.

The barring interface component 150 includes a barring base portion 152 and a barring interface portion 154. The barring base portion 152 is coupled to the crankshaft 122. The barring interface portion 154 extends from the barring base portion 152. The barring interface portion 154 is configured to be engaged by a barring tool to facilitate manual rotation of the crankshaft assembly 120.

The barring base portion 152 defines a barring bore opening 156 extending at least partially through the barring base portion 152 and a plurality of barring mounting apertures 158 (e.g., third apertures, etc.) extending through the barring base portion 152. The barring bore opening 156 is configured to selectively align with and receive the crankshaft alignment portion 128 of the crankshaft 122 to align the barring interface component 150 with the crankshaft 122. The mounting apertures 158 of the barring interface component 150, the damper mounting apertures 144 of the damper 140, and the coupling apertures 130 of the crankshaft 122 align to selectively receive a plurality of fasteners 160 (e.g., bolts, screws, pins, etc.) to selectively couple the barring interface component 150 and the damper 140 to the crankshaft 122. In other words, each mounting aperture 158 aligns with a damper mounting aperture 144 and a coupling aperture 130.

The fasteners 160 may facilitate the transfer of torque between the barring interface component 150, the damper 140, and the crankshaft 122. For example, the fasteners 160 may facilitate the transfer of torque from the crankshaft 122 to the damper 140 such that the damper 140 may absorb and dissipate vibrations in the crankshaft 122. As another example, the fasteners 160 may facilitate the transfer of torque from the barring interface component 150 to the crankshaft 122 when an operator engages the barring interface component 150 with a barring tool to facilitate manual rotation of the crankshaft assembly 120 by the operator.

In some embodiments, when the barring bore opening 156 of the barring interface component 150 and the damper bore opening 142 of the damper 140 receive the crankshaft alignment portion 128 of the crankshaft 122, the damper mounting apertures 144 of the damper 140 and the mounting apertures 158 of the barring interface component 150 align with the coupling apertures 130 of the crankshaft 122 to selectively receive the fasteners 160 to couple the barring interface component 150 and the damper 140 to the crankshaft 122. For example, an operator may slide the crankshaft alignment portion 128 through the damper bore opening 142 and the barring bore opening 156 to align the mounting apertures 158, the damper mounting apertures 144, and the coupling apertures 130 before inserting the fasteners 160 through the mounting apertures 158, the damper mounting apertures 144, and the coupling apertures 130 to couple the barring interface component 150, the damper 140, and the crankshaft 122.

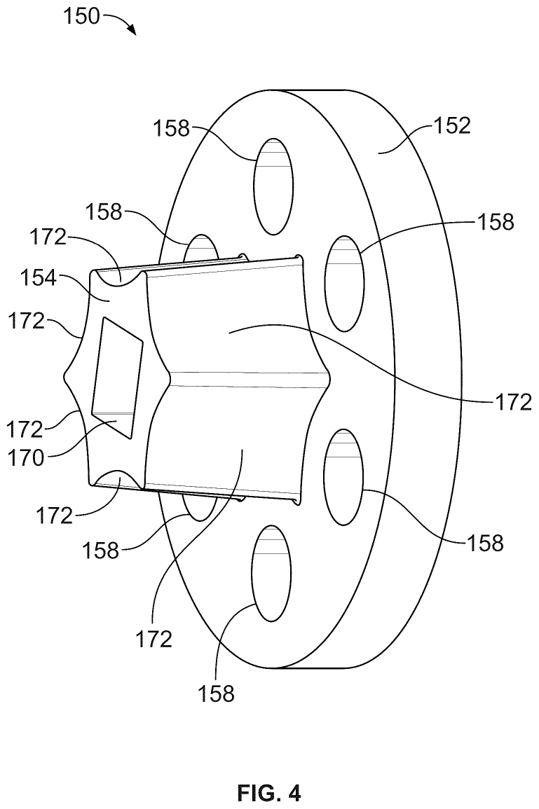

As shown in FIG. 4, the barring interface portion 154 includes a barring tool interface opening 170 extending at least partially into the barring interface portion 154. The barring tool interface opening is configured to be engaged by a barring tool to facilitate manual rotation of the crankshaft assembly 120 (e.g., receive a rotational input from a barring tool, etc.). For example, the barring tool interface opening 170 may have a 0.5 inch by 0.5 inch square profile configured to be engaged by a barring tool with a 0.5 inch barring feature to facilitate manual rotation of the crankshaft assembly 120. In the event that the barring feature of the barring tool has a different shape and/or size, the barring tool interface opening 170 can have a shape and/or size that corresponds to the barring feature.

In some embodiments, the barring tool interface opening 170 extends through the barring interface component 150 to the barring bore opening 156. In other embodiments, the barring tool interface opening 170 extends partially through the barring interface portion 154. In still other embodiments, the barring interface portion 154 includes a barring tool interface on an outside of the barring interface portion 154 (e.g., defined by an outside surface of the barring interface portion 154, etc.) configured to be engaged by a barring tool to facilitate manual rotation of the crankshaft assembly 120. For example, the barring interface portion 154 may have a 0.5 inch square outer profile configured to be received by a 0.5 inch by 0.5 inch square opening of a barring tool such that the barring tool engages the barring interface portion 154. In the event that the opening of the barring tool has a different shape and/or size, the outer profile of the barring interface portion 154 can have a shape and/or size that corresponds to the opening of the barring tool.

The barring tool interface opening 170 may be positioned on a same side of the crankshaft assembly 120 as the alignment indicators 146 positioned on the damper 140 such that an operator of the internal combustion engine system 100 may manually rotate the crankshaft assembly 120 while visually monitoring the alignment indicators 146. For example, the damper 140 may be positioned between the barring interface component 150 and the crankshaft 122, and the alignment indicators 146 may be positioned on a side of the damper 140 oriented towards the barring interface component 150. As a result, an operator may continually rotate the crankshaft assembly 120 via the barring interface component 150 until the alignment indicators 146 indicate that the crankshaft assembly 120 is in a rotational position desired by the operator. For example, the operator may simultaneously monitor the rotational position of the crankshaft assembly 120 via the alignment indicators 146 while manually rotating the crankshaft assembly 120 via the barring interface component 150.

As shown in FIG. 4, the barring interface portion 154 defines a plurality of fastener profiles 172 each configured to align with a respective fastener 160 when the fasteners 160 extend through the mounting apertures 158. The fastener profiles 172 may allow for clearance between the fasteners 160 and the barring interface portion 154 to allow for the fasteners 160 to abut (e.g., contact, etc.) the barring base portion 152 while coupling the barring interface component 150 to the crankshaft 122. For example, the fastener profiles 172 correspond with fastener heads of the fasteners 160 to allow for the fasteners 160 to abut the barring base portion 152. In the embodiment of FIG. 4, each fastener profile 172 comprises a curved surface. Each curved surface may be concentric with a corresponding mounting aperture 158 (and thereby a respective fastener 160).

In some embodiments, the barring interface component 150 can be manufactured as a modular component configured to provide a retrofit solution for facilitating manual rotation of the crankshaft assembly 120. For example, the mounting apertures 158 of the barring interface component 150 may be configured to align with existing damper mounting apertures 144 of the damper 140 and existing coupling apertures 130 of the crankshaft 122 such that the barring interface component 150 may be retroactively coupled to the crankshaft 122 and the damper 140 to facilitate manual rotation of the crankshaft assembly 120. Therefore, installing the barring interface component 150 into an existing crankshaft assembly 120 may facilitate manual rotation of the crankshaft assembly 120 without requiring the purchase or manufacturing of a new crankshaft assembly 120.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

References herein to the positions of elements are merely used to describe the orientation of various elements in the FIGURES. It should be noted that the orientation of various elements may differ according to other example embodiments, and that such variations are intended to be encompassed by the present disclosure.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

What is claimed is:

1. A crankshaft assembly for an internal combustion engine, the crankshaft assembly comprising:
a crankshaft defining a plurality of crankshaft apertures; and
a barring interface component configured to be engaged by a barring tool to facilitate rotation of the crankshaft assembly, the barring interface component defining a plurality of barring interface mounting apertures, each of the plurality of barring interface mounting apertures configured to align with one of the plurality of crankshaft apertures to selectively receive one of a plurality of fasteners to couple the barring interface component to the crankshaft.

2. The crankshaft assembly of claim 1, further comprising a damper defining a plurality of damper mounting apertures, wherein each of the plurality of barring interface mounting apertures is configured to align with one of the plurality of damper mounting apertures to selectively receive one of the plurality of fasteners to couple the barring interface component and the damper to the crankshaft.

3. The crankshaft assembly of claim 2, wherein the damper comprises one or more inertial rings configured to absorb energy of vibrations in the crankshaft.

4. The crankshaft assembly of claim 2, wherein:
the damper defines a plurality of alignment indicators corresponding to different rotational positions of the crankshaft assembly;
the damper is positioned between the crankshaft and the barring interface component; and
the plurality of alignment indicators are oriented toward the barring interface component.

5. The crankshaft assembly of claim 2, wherein:
the barring interface component defines a barring interface bore extending at least partially through the barring interface component;
the damper defines a damper bore extending through the damper; and
the crankshaft comprises:
a crankshaft alignment portion configured to extend through the damper bore and into the barring interface bore to facilitate alignment of the plurality of crankshaft apertures, the plurality of damper mounting apertures, and the plurality of barring interface mounting apertures.

6. The crankshaft assembly of claim 5, wherein:
the crankshaft further comprises:
a crankshaft body portion, and
a crankshaft coupling portion extending from an end of the crankshaft body portion, the crankshaft coupling portion defining the plurality of crankshaft apertures; and
the crankshaft alignment portion extends from an end of the crankshaft coupling portion.

7. The crankshaft assembly of claim 6, wherein the plurality of crankshaft apertures do not extend into the crankshaft body portion.

8. The crankshaft assembly of claim 1, wherein the barring interface component comprises:
a barring base portion defining the plurality of barring interface mounting apertures; and
a barring interface portion defining a barring tool interface opening configured to be engaged by the barring tool to facilitate the rotation of the crankshaft assembly.

9. The crankshaft assembly of claim 8, wherein the barring tool interface opening has a square profile configured to be engaged by a square barring feature of the barring tool to facilitate manual rotation of the crankshaft assembly.

10. The crankshaft assembly of claim 1, wherein the barring interface component comprises:
a barring base portion defining the plurality of barring interface mounting apertures; and
a barring interface portion including a barring tool interface defined by an outside surface of the barring interface portion, the barring tool interface configured to be engaged by the barring tool to facilitate the rotation of the crankshaft assembly.

11. The crankshaft assembly of claim 10, wherein the outside surface of the barring tool interface has square outer profile configured to be received by a square opening of the barring tool such that the barring tool engages the barring interface portion.

12. The crankshaft assembly of claim 1, wherein the barring interface component defines a plurality of fastener profiles, each of the plurality of fastener profiles configured to align with one of the plurality of fasteners when the plurality of fasteners are received by the plurality of barring interface mounting apertures.

13. The crankshaft assembly of claim 12, wherein each of the plurality of fastener profiles comprises a curved surface.

14. The crankshaft assembly of claim 13, wherein each curved surface is substantially concentric with a corresponding barring interface mounting aperture of the plurality of barring interface mounting apertures.

15. An engine system, comprising:
an engine including:
a plurality of cylinders; and
the crankshaft assembly of claim 1 coupled to the plurality of cylinders and configured to be driven to rotate by combustion within the plurality of cylinders.

16. The engine system of claim 15, wherein the crankshaft assembly further comprises a damper defining a plurality of damper mounting apertures, wherein each of the plurality of barring interface mounting apertures is configured to align with one of the plurality of damper mounting apertures to selectively receive one of the plurality of fasteners to couple the barring interface component and the damper to the crankshaft.

17. The engine system of claim 16, wherein:
the barring interface component defines a barring interface bore extending at least partially through the barring interface component;
the damper defines a damper bore extending through the damper; and
the crankshaft comprises:
a crankshaft alignment portion configured to extend through the damper bore and into the barring interface bore to facilitate alignment of the plurality of crankshaft apertures, the plurality of damper mounting apertures, and the plurality of barring interface mounting apertures.

18. The engine system of claim 17, wherein:
the crankshaft further comprises:
a crankshaft body portion, and
a crankshaft coupling portion extending from an end of the crankshaft body portion, the crankshaft coupling portion defining the plurality of crankshaft apertures; and
the crankshaft alignment portion extends from an end of the crankshaft coupling portion.

19. The engine system of claim 15, wherein the barring interface component defines a plurality of fastener profiles, each of the plurality of fastener profiles configured to align with one of the plurality of fasteners when the plurality of fasteners are received by the plurality of barring interface mounting apertures.

20. The engine system of claim 15, wherein the barring interface component comprises:
a barring base portion defining the plurality of barring interface mounting apertures; and
a barring interface portion defining a barring tool interface opening configured to be engaged by the barring tool to facilitate the rotation of the crankshaft assembly.
